(19) United States
(12) Patent Application Publication
(10) Pub. No.: US 2026/0249904 A1
(43) Pub. Date: Aug. 27, 2026

(54) METHOD FOR DETECTING A VEHICLE SKIDDING

(71) Applicant: JTEKT EUROPE, Irigny (FR)

(72) Inventors: Yoann BAUDIN, Lyon (FR); Quentin FRAISON, Irigny (FR)

(73) Assignee: JTEKT EUROPE, Irigny (FR)

(21) Appl. No.: 19/545,859

(22) Filed: Feb. 20, 2026

(30) Foreign Application Priority Data
Feb. 21, 2025 (FR) 2501808

(51) Int. Cl. B62D 6/00; B62D 15/02

(52) U.S. Cl. CPC B62D 6/003; B62D 15/021

(57) ABSTRACT

Method (100) for detecting a loss of grip in a vehicle equipped comprising a power steering system, the method (100) comprising:
at least one first measurement (101) by a first sensor configured to measure a first physical quantity representative of a driving direction defined by a driver 5 of the vehicle;
at least one second measurement (102) by a second sensor configured to measure a second physical quantity representative of a vehicle response to the driving direction;
a determination (103) of vehicle oversteer (SURV) or a vehicle understeer (SOUV) based on a criterion that is a function of at least one first measurement and at least one second measurement.

The present invention concerns the field of power steering systems, and in particular to the detection of a loss of grip of a vehicle equipped with a power steering system.

It is important to warn the driver of a loss of grip in a vehicle equipped with an electric power steering system by improving the quality of the information provided when a vehicle skidding occurs, so as to make it possible to propose and activate certain particular functions, for example a reduction in a steering wheel torque when the vehicle is understeering or an increase in counter-steering when the vehicle is oversteering.

The invention therefore aims to provide a solution to all or part of these problems.

To this end, the present invention concerns a method for detecting a loss of grip of a vehicle comprising a power steering system, the method comprising:
at least one first measurement by a first sensor configured to measure a first physical quantity representative of a driving direction defined by the vehicle's driver;
at least one second measurement by a second sensor configured to measure a second physical quantity representative of a reaction of the vehicle to the driving direction;
a determination of an oversteer condition of the vehicle or an understeer condition of the vehicle on the basis of a criterion that is a function of the at least one first measurement and the at least one second measurement.

According to these arrangements, it is possible to detect a vehicle skidding and to provide the driver with information in order to activate, or to automatically directly activate, complementary functions such as, for example, a reduction in steering wheel torque when the vehicle is understeering, or, an increase in counter-steering of the front axle when the vehicle is oversteering.

According to one implementation mode, the invention comprises one or more of the following features, alone or in a technically acceptable combination.

According to one implementation mode, the first physical quantity is a steering wheel rotation angle θ_{steering wheel} of the vehicle.

According to one implementation mode, the second physical quantity is a lateral acceleration of the vehicle or a yaw rate ψ of the vehicle.

According to one implementation mode, an equivalent steering wheel rotation θ_{eq} of the vehicle is determined based on at least one second measurement.

According to one implementation mode, the equivalent steering wheel rotation θ_{eq} is defined by

$${θ}_{eq} = \frac{K * \dot{ψ}}{V} ,$$

where V is the vehicle speed and K is a constant value that is a function of the vehicle's wheelbase E and the ratio of the steering wheel rotation angle θ_{steering wheel} to the steered wheel rotation angle α of the vehicle.

According to one implementation mode, the criterion comprises the following conditions (1) and (2):

$$( {θ}_{eq} > 0 ) \qquad ( 1 )$$

$$and$$

$$( {θ}_{eq} > {θ}_{steering wheel} ) ;$$

$$( {θ}_{eq} < 0 ) \qquad ( 2 )$$

$$and$$

$$( {θ}_{eq} < {θ}_{steering wheel} ) ;$$

the vehicle being determined to be oversteering if either of the criteria conditions is met, the vehicle being determined to be understeering if neither condition is met.

According to one implementation mode, the oversteer rate is defined as the product of the maximum oversteer and an oversteer coefficient that is a function of the equivalent steering wheel rotation θ_{eq} and the steering wheel rotation angle θ_{steering wheel}.

According to one implementation mode, an understeer rate is defined as the product of the maximum understeer and an understeer coefficient that is a function of the equivalent steering wheel rotation deg and the steering wheel rotation angle θ_{steering wheel}.

According to one implementation mode, the oversteer coefficient is the minimum of a first value and a second value, the first value is a first function of the absolute value of the equivalent steering wheel rotation θ_{eq}, the second value is a second function of the absolute value of the difference between the steering wheel rotation angle steering wheel and the equivalent steering wheel rotation θ_{eq}.

According to one implementation mode, the first function is constant and equal to 0 when the absolute value of the equivalent steering wheel rotation θ_{eq} is comprised between 0 and a first lower threshold, and in which the first function is constant and equal to 1 when the absolute value of the equivalent steering wheel rotation θ_{eq} is greater than a first upper threshold, and in which the first function is increasing, for example, linearly, between 0 and 1 in the interval between the first lower threshold and first upper threshold.

According to one implementation, the second function is constant and equal to 0 when the absolute value of the difference between the steering wheel rotation angle θ_{steering wheel} and the equivalent steering wheel rotation θ_{eq} is comprised between 0 and a second lower threshold, and in which the second function is constant and equal to 1 when the absolute value of the difference between the steering wheel rotation angle θ_{steering wheel} and the equivalent steering wheel rotation deg is greater than a second upper threshold, and in which the second function K2 is increasing, for example linearly, between 0 and 1 in the interval between the second lower threshold and the second upper threshold.

According to one implementation mode, the understeer coefficient is a minimum of a third value and a fourth value, the third value being a third function of the absolute value of the equivalent steering wheel rotation θ_{eq}, and the fourth value being a fourth function of an absolute value of a difference between the steering wheel rotation angle θ_{steering wheel} and the equivalent steering wheel rotation θ eq.

According to one implementation, the third function is constant and equal to 0 when the absolute value of the equivalent steering wheel rotation θ_{eq} is comprised between 0 and a third lower threshold, and in which the third function is constant and equal to 1 when the absolute value of the equivalent steering wheel rotation θ_{eq} is greater than a third upper threshold, and in which the third function is linear between 0 and 1 in the interval between the third lower threshold and the third upper threshold.

According to one implementation mode, the fourth function is constant and equal to 0 when the absolute value of a difference between the steering wheel rotation angle θ_{steering wheel} and the equivalent steering wheel rotation θ_{eq} is comprised between 0 and a fourth lower threshold, and in which the fourth function is constant and equal to 1 when the absolute value of a difference between the steering wheel rotation angle θ_{steering wheel} and the equivalent steering wheel rotation θ_{eq} is greater than a fourth upper threshold, and in which the fourth function is linear between 0 and 1 in the interval between the fourth lower threshold and the fourth upper threshold.

According to one implementation mode, the at least one first measurement comprises a plurality of first measurements filtered by a first frequency filter, and in which the at least one second measurement comprises a plurality of second measurements filtered by a second frequency filter.

According to one implementation mode, the first frequency filter and the second frequency filter are configured to allow the frequencies comprised between 0.5 Hz and 10 Hz to pass, preferably between 1 Hz and 5 Hz.

According to these arrangements, the first measurement and second measurement will be synchronized.

According to one aspect, the present invention concerns a vehicle comprising a power steering or steer-by-wire system and an electronic steering system control unit configured to:
collect at least one first measurement from a first sensor configured to measure a first physical quantity representative of a driving direction defined by a driver of the vehicle;
collect at least one second measurement from a second sensor configured to measure a second physical quantity representative of a vehicle reaction to the driving direction;
the electronic control unit being further configured to implement the method 100 according to one of the embodiments described above.

For its proper understanding, an embodiment and/or implementation mode of the invention is described with reference to the accompanying drawings, which represent, by way of non-limiting example, an embodiment or implementation mode of a device and/or a method according to the invention. The same reference numerals in the drawings designate similar elements or elements with similar functions.

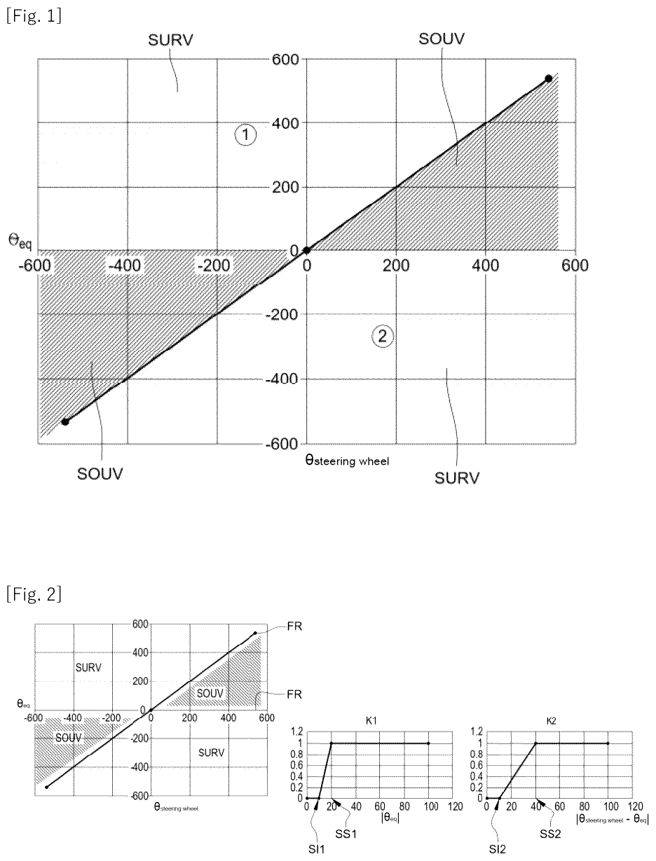

FIG. 1 is a graphical representation of the points corresponding respectively to an oversteer zone and an understeer zone, the points being determined by a first value along a first horizontal axis equal to a steering wheel rotation angle θ_{steering wheel} of the vehicle, and by a second value along a second vertical axis equal to an equivalent steering wheel rotation θ_{eq} determined on the basis of a lateral acceleration of the vehicle or a yaw rate \dot{ψ} of the vehicle.

FIG. 2 is another graphical representation of the points corresponding respectively to an oversteer zone and an understeer zone, in which the oversteer and understeer zones are truncated near a boundary between these zones, the truncation being symmetrical on both sides of said boundary.

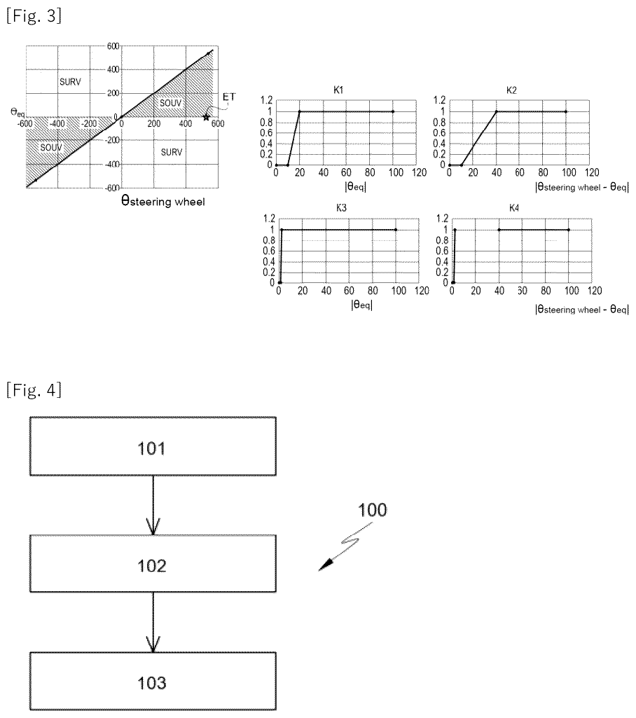

FIG. 3 is another graphical representation of the points corresponding respectively to an oversteer zone and an understeer zone, in which the oversteer and understeer zones are truncated near a boundary between these zones, the truncation being asymmetrical on both sides of said boundary.

FIG. 4 is a schematic representation of a sequential diagram of the method steps according to one embodiment of the invention.

A vehicle equipped with an electric power steering system may comprise, in particular, as is known to those skilled in the art, a subsystem comprising a power steering motor and its control unit, coupled via an associated reduction gear, to a subassembly comprising a rack and a pinion. A torque sensor is usually configured on a transmission shaft of a steering member in order to estimate a driver torque. The assist motor control unit is configured to calculate the assist torque as a function of the driver torque estimated by the torque sensor and on the basis of information originating from an internal vehicle network, such as for example a vehicle speed or a vehicle lateral acceleration, etc. The invention can also be used in a vehicle equipped with an electrically controlled steering system of the «steer-by-wire» type.

The perception of a loss of grip is influenced by internal friction within the electric power steering system, by damping affects, by the quality of the assist control and by all the adjustments intended to provide comfort to the driver and passengers.

In order to improve the quality of the information provided to the driver when a vehicle skidding occurs, and in order to make it possible to propose to the driver and/or to activate certain complementary functions, such as, for example, a reduction in steering wheel torque when the vehicle is understeering or an increase in counter-steering when the vehicle is oversteering, it is important to be able to detect oversteer or understeer condition and to be able to independently determine an oversteer rate and understeer rate of the vehicle.

The present invention therefore concerns a method 100 for detecting a loss of grip in a vehicle equipped comprising a power steering system, the method 100 comprising the following steps, schematically represented in FIG. 4:
at least one first measurement 101 by a first sensor configured to measure a first physical quantity representative of a driving direction defined by a driver of the vehicle;
at least one second measurement 102 by a second sensor configured to measure a second physical quantity representative of a reaction of the vehicle to the driving direction;
A determination 103 of an oversteer SURV of the vehicle or an understeer SOUV of the vehicle on the basis of a criterion that is a function of at least one first measurement and at least one second measurement.

The first physical quantity is, for example, the steering wheel rotation angle θ_{steering wheel} of the vehicle.

The second physical quantity is, for example, a lateral acceleration of the vehicle or a yaw rate \dot{ψ} of the vehicle.

In particular, an equivalent steering wheel rotation θ_{eq} of the vehicle can be determined on the basis of the at least one second measurement of the lateral acceleration or of the yaw rate, by means of relationships known to those skilled in the art, which make it possible, on the one hand, to relate the yaw rate y of the vehicle to a vehicle speed V and to a curvature radius R of a trajectory of the vehicle, on the other hand, to express an angular orientation of the front wheels as a function of a wheelbase E of the vehicle and the curvature radius R, and finally, to determine a constant ratio between a steering wheel angular orientation θ_{steering wheel} and the angular orientation α of the steered wheels of the vehicle.

For example, the following relationship is obtained θ_{eq}=K*\dot{ψ}N, where K is a constant that is a function of the constant ratio between the steering wheel angular orientation θ_{steering wheel} and the angular orientation α of the steered wheels of the vehicle, and the wheelbase E of the vehicle. A similar relationship may be obtained using the lateral acceleration of the vehicle instead of the yaw rate.

According to these arrangements, a graphical representation may be obtained of the points defined by their coordinates θ_{eq} and θ_{steering wheel}, which correspond respectively to an oversteer condition SURV of the vehicle or to an understeer condition SOUV of the vehicle, as illustrated in FIG. 1. The points are thus defined by a first value along a first horizontal axis equal to the steering wheel rotation angle θ_{steering wheel}, and by a second value along a second vertical axis equal to the equivalent steering wheel rotation θ_{eq} determined on the basis of the lateral acceleration of the vehicle or of a yaw rate \dot{ψ} of the vehicle.

The criterion which allows to determine whether the vehicle is in an oversteer condition SUR or in an understeer condition SOUV comprises, for example, the following two conditions (1) and (2):

$$( {θ}_{eq} > 0 )$$

$$and$$

$$( {θ}_{eq} > {θ}_{steering wheel} ) ;$$

$$( {θ}_{eq} < 0 )$$

$$and$$

$$( {θ}_{eq} < {θ}_{steering wheel} ) ;$$

Such that, according to one implementation of the method, the vehicle is determined to be in an oversteer condition SURV if one of the criteria is met, while the vehicle is determined to be in an understeer condition SOUV if none of the conditions of the criteria is met.

According to these arrangements, it is possible to detect vehicle skidding and send information to the driver in order to activate, or to directly and automatically activate, complementary functions such as, for example, a reduction in steering wheel torque when the vehicle is understeering, or, for example, an increase in counter-steering of the front axle when the vehicle is oversteering.

In order to take into account approximations related to sensor accuracy, simplified calculations, and certain delays, it may be advantageous to partially truncate the oversteer SURV and the understeer SOUV zones in the vicinity of the boundary FR between these two zones, as illustrated in FIG. 2. For this purpose, it is possible, for example, to define a first truncation function K1 and a second truncation function K2, if, for example, a symmetric truncation on either side of the boundary FR is sought.

Thus, an oversteer rate is defined as equal to a product of a maximum oversteer, the maximum oversteer being for example equal to 1, and an oversteer coefficient that is a function of the equivalent steering wheel rotation θ_{eq} and of the steering wheel rotation angle θ_{steering wheel}: for example, the oversteer coefficient is a minimum between a first function K1 of an absolute value of the equivalent steering wheel rotation θ_{eq}, and the second function K2 of an absolute value of a difference between the steering wheel rotation angle θ_{steering wheel} and the equivalent steering wheel rotation of the θ_{eq}. In particular, the first function K1 is constant and equal to 0 when the absolute value of the equivalent steering wheel rotation θ_{eq} is comprised between 0 and a first lower threshold SI1, and the first function K1 is constant and equal to 1 when the absolute value of the equivalent steering wheel rotation θ_{eq} is greater than a first upper threshold SS1, and the first function K1 varies linearly between 0 and 1 in the interval between the first lower threshold SI1 and the first upper threshold SS1. Similarly, the second function K2 is constant and equal to 0 when the absolute value of the difference between the steering wheel rotation angle θ_{steering wheel} and the equivalent steering wheel rotation θ_{eq} is comprised between 0 and a second lower threshold SI2, and the second function K2 is constant and equal to 1 when the absolute value of the difference between the steering wheel rotation angle θ_{steering wheel} and the equivalent steering wheel rotation θ_{eq} is greater than a second upper threshold SS2, and the second function K2 varies linearly between 0 and 1 in the interval between the second lower threshold SI2 and the second upper threshold SS2.

If a symmetrical truncation on either side of the boundary FR is sought, it is possible to similarly determine an understeer rate based on a maximum understeer, the maximum understeer being for example equal to 1, and on an understeer coefficient equal, by way of example, to the oversteer coefficient described above.

According to another example of implementation, an asymmetrical truncation on either side of the boundary FR can be sought; it is thus possible to define an understeer coefficient that is distinct from the oversteer coefficient described above; in this case, for example, as illustrated in FIG. 3, the understeer coefficient may be the minimum of a third function K3 and a fourth function K4, said third function being a function of the absolute value of the equivalent steering wheel rotation deg, and said fourth function being a function of the absolute value of the difference between the steering wheel rotation angle θ_{steering wheel} and the equivalent steering wheel rotation θ_{eq}. For example, the third function K3 is constant and equal to 0 when the absolute value of the equivalent steering wheel rotation θ_{eq} is comprised between 0 and a third lower threshold, and the third function K3 is constant and equal to 1 when the absolute value of the equivalent steering wheel rotation deg is greater than a third upper threshold, and the third function K3 varies linearly between 0 and 1 in the interval between the third lower threshold and the third upper threshold. Similarly, for example, the fourth function K4 is constant and equal to 0 when the absolute value of the difference between the steering wheel rotation angle θ_{steering wheel} and the equivalent steering wheel rotation θ_{eq} is comprised between 0 and a fourth lower threshold, and the fourth function K4 is constant and equal to 1 when the absolute value of said difference is greater than a fourth upper threshold, and the fourth function K4 varies linearly between 0 and 1 in the interval between the fourth lower threshold and the fourth upper threshold.

According to these arrangements, asymmetric truncations of the oversteer and understeer zones are obtained on either side of the boundary between these zones. The star ET shown in FIG. 3 is positioned at a point in the plane that corresponds to a very high understeer when the equivalent steering wheel rotation θ_{eq} has a low positive value, and that corresponds to a very low oversteer when the equivalent steering wheel rotation θ_{eq} has a low negative value. In order to ensure, in such a situation, a sufficient rate of detection of an understeer, while accepting that a very low oversteer is not detected, an asymmetric truncation is required. More generally, the asymmetric truncation makes it possible, depending on the boundary FR in the vicinity of which it is applied, to give priority to the detection of an understeer or of an oversteer in the vicinity of said boundary FR.

According to one example of implementation, the first, second, third and fourth lower and upper thresholds are determined empirically.

According to these arrangements, in the case of understeer for example, the method 100 according to the invention determines a rate between 0 and 1, i.e. 0 corresponding to «no understeer», and 1 corresponding to a fully steered steering wheel without vehicle response. In this case, the method may comprise a correction step by an automatic modification of a «target steering wheel torque», for example by multiplying it by (1-rate), according to a complementary method described in document WO2011010058A1.

In the case of oversteer, for example, the method may comprise a correction step involving an automatic increase in the contribution of a «yaw rate» term in a calculation of a return function, according to another complementary method described in document FR3086920B1.

According to one example of implementation, the first measurements and the second measurements are filtered by means of a frequency filter, for example a filter that passes frequencies between 0.5 Hz and 10 Hz, preferably a filter that passes frequencies between 1 Hz and 5 Hz. Indeed, the signal corresponding to the equivalent rotation θ_{eq} is related to vehicle dynamics, which are relatively slow due to the mass and inertia of the vehicle, as well as to suspension compliance, whereas the signal corresponding to the steering wheel rotation θ_{steering wheel} is related to faster dynamics, since it corresponds to the driver command. Filtering these signals therefore makes it possible to bring into phase, or to synchronize, the primary signal originating from the driver and the secondary signal corresponding to a reaction of the vehicle to the primary signal, before comparing them in the same plane, as illustrated in FIG. 1.

According to one aspect, the present invention concerns a vehicle comprising a power steering system or a «steer-by-wire» system and an electronic control unit of the steering system configured to:
collect at least one first measurement from a first sensor configured to measure a first physical quantity representative of a driving direction defined by a driver of the vehicle;
collect at least one second measurement from a second sensor configured to measure a second physical quantity representative of a reaction of the vehicle to the driving direction;
the electronic control unit being further configured to implement the method 100 according to one of the implementation modes described above.

1. A method for detecting a loss of grip in a vehicle comprising a power steering system, the method comprising:
at least one first measurement by a first sensor configured to measure a first physical quantity representative of a driving direction defined by a driver of the vehicle;
at least one second measurement by a second sensor configured to measure a second physical quantity representative of a vehicle response to the driving direction;
a determination of vehicle oversteer or a vehicle understeer based on a criterion that is a function of the at least one first measurement and the at least one second measurement;
in which the first physical quantity is a steering wheel rotation angle θ_{steering wheel} of the vehicle;
in which the second physical quantity is a lateral acceleration of the vehicle or a yaw rate \dot{ψ} of the vehicle;
in which an equivalent steering wheel rotation θ_{eq} of the vehicle is determined based on the at least one second measurement;
in which the criterion comprises the following conditions (1) and (2):
$$( {θ}_{eq} > 0 )$$
$$and$$
$$( {θ}_{eq} > {θ}_{steering wheel} ) ;$$
$$( {θ}_{eq} < 0 )$$
$$and$$
$$( {θ}_{eq} < {θ}_{steering wheel} ) ;$$
the vehicle being determined to be oversteering if one of the conditions of the criterion is met, the vehicle being determined to be understeering if none of the conditions of the criterion are met;
in which an oversteer rate is defined as the product of a maximum oversteer and an oversteer coefficient that is a function of the equivalent steering wheel rotation θ_{eq} and the steering wheel rotation angle θ_{steering wheel},
in which the oversteer coefficient is a minimum of a first value and a second value, the first value being a first function K1 with an absolute value of the equivalent steering wheel rotation θ_{eq}, the second value being a second function K2 with an absolute value of the difference between the steering wheel rotation angle θ_{steering wheel} and the equivalent steering wheel rotation θ_{eq}.

2. The method according to claim 1, wherein the first function K1 is constant and equal to 0 when the absolute value of the equivalent steering wheel rotation θ_{eq} is comprised between 0 and a first lower threshold, and wherein the first function K1 is constant and equal to 1 when the absolute value of the equivalent steering wheel rotation θ_{eq} is greater than a first upper threshold, and in which the first function K1 is increasing, for example linearly, between 0 and 1 in the interval between the first lower threshold and the first upper threshold.

3. The method according to claim 1, wherein the second function K2 is constant and equal to 0 when the absolute value of the difference between the steering wheel rotation angle θ_{steering wheel} and the equivalent steering wheel rotation θ_{eq} is comprised between 0 and a second lower threshold, and wherein the second function K2 is constant and equal to 1 when the absolute value of the difference between the steering wheel rotation angle θ_{steering wheel} and the equivalent steering wheel rotation θ_{eq} is greater than a second upper threshold, and wherein the second function K2 is increasing, for example linearly, between 0 and 1 in the interval between the second lower threshold and the second upper threshold.

4. A method for detecting a loss of grip of a vehicle comprising a power steering system, the method comprising:
at least one first measurement by a first sensor configured to measure a first physical quantity representative of a driving direction defined by a driver of the vehicle;
at least one second measurement by a second sensor configured to measure a second physical quantity representative of a vehicle response to the driving direction;
a determination of a vehicle oversteer or a vehicle understeer based on a criterion that is a function of the at least one first measurement and the at least one second measurement;
in which the first physical quantity is a steering wheel rotation angle steering wheel of the vehicle;
in which the second physical quantity is a lateral acceleration of the vehicle or a yaw rate \dot{ψ} of the vehicle;
in which an equivalent steering wheel rotation θ_{eq} of the vehicle is determined based on the at least one second measurement;
the criterion comprises the following conditions (1) and (2):
$$( {θ}_{eq} > 0 )$$
$$and$$
$$( {θ}_{eq} > {θ}_{steering wheel} ) ;$$
$$( {θ}_{eq} < 0 )$$
$$and$$
$$( {θ}_{eq} < {θ}_{steering wheel} ) ;$$
the vehicle being determined to be oversteering if one of the conditions of the criterion is met, the vehicle being determined to be understeering if none of the conditions of the criterion are met;
in which an understeer rate is defined as the product of a maximum understeer and an understeer coefficient that is a function of the equivalent steering wheel rotation θ eq and the steering wheel rotation angle θ_{steering wheel},
in which the understeer coefficient is a minimum of a third and a fourth value, the third value being a third function K3 with an absolute value of the equivalent steering wheel rotation θ_{eq}, the fourth value being a fourth function K4 with an absolute value of a difference between the steering wheel rotation angle θ_{steering wheel} and the equivalent steering wheel rotation θ_{eq}.

5. The method according to claim 4, wherein the third function K3 is constant and equal to 0 when the absolute value of the equivalent steering wheel rotation θ_{eq} is comprised between 0 and a third lower threshold, and wherein the third function K3 is constant and equal to 1 when the absolute value of the equivalent steering wheel rotation θ_{eq} is greater than a third upper threshold, and wherein the third function K3 is linear between 0 and 1 in the interval between the third lower threshold and the third upper threshold.

6. The method according to claim 4, wherein the fourth function K4 is constant and equal to 0 when the absolute value of a difference between the steering wheel rotation angle θ_{steering wheel} and the equivalent steering wheel rotation θ_{eq} is comprised between 0 and a fourth lower threshold, and wherein the fourth function K4 is constant and equal to 1 when the absolute value of the difference between the steering wheel rotation angle θ_{steering wheel} and the equivalent steering wheel rotation θ_{eq} is greater than a fourth upper threshold, and wherein the fourth function K4 is linear between 0 and 1 in the interval between the fourth lower threshold and the fourth upper threshold.

7. The method according to claim 1, wherein the at least one first measurement comprises a plurality of first measurements filtered by a first frequency filter, and wherein the at least one second measurement comprises a plurality of second measurements filtered by a second frequency filter.

8. A vehicle comprising a power steering or steer-by-wire system and an electronic steering system control unit configured to:
collect at least one first measurement from a first sensor configured to measure a first physical quantity representative of a driving direction defined by a driver of the vehicle;
collect at least one second measurement from a second sensor configured to measure a second physical quantity representative of a vehicle's reaction to the driving direction;
the electronic control unit being further configured to implement the method according to claim 1.
